(19) United States
(12) Patent Application Publication
(10) Pub. No.: US 2002/0133466 A1
(43) Pub. Date: Sep. 19, 2002

(54) Internet payment system

(76) Inventor: James B. Pugh, Gilbert, AZ (US)

Correspondence Address: Philip M. Weiss, Weiss & Weiss PC, Suite 305, 500 Old Country Road, Garden City, NY, 11530, US

(21) Appl. No.: 09/805,485

(22) Filed: Mar. 13, 2001

(51) Int. Cl. G06F 17/60

(52) U.S. Cl. 705/64

(57) ABSTRACT

The present invention relates to a system and method for financial transactions on the Internet.

### FIELD OF THE INVENTION

The present invention relates to a system and method for financial transactions on the Internet.

### BACKGROUND OF THE INVENTION

When a financial transaction is performed on the Internet, the seller or merchant selects its gateway provider, a merchant account and transaction processing center. The largest gateway provider in the market today is Verisign. The merchant must find a bank to provide an Internet merchant account. Once the merchant account is established, a processing center is contracted with to process the transaction. The processing center can be done through a bank, but can also be done through the gateway provider. Higher merchant service fees are charged for an Internet transaction due to the inability to have card present transactions. Visa rates can range from 2.25% to 14%. Additional charges include processing fees, gateway fees and monthly reporting fees. Purchases are only made via manual entry of a credit card. Manual entry means that the purchaser must keep in their e-Commerce shopping carts, their credit card number, expiration date and mailing address of the credit card. The process center as part of its verification, matches the billing address with the mailing address that the purchaser keys into the e-Commerce shopping cart.

In the prior art, the merchant can apply on-line for bank accounts. The merchant must search the Internet to find out where they can apply. The application is only for certain US banks.

Present payment methods include the shopping cart, gateways to processing centers, manual entry of credit cards and merchant services. Current systems that provide for on-line checking today, are not processed as an ACH transaction, but as a regular check in the banking system with the normal clearing process.

### SUMMARY OF THE INVENTION

The merchant communicates to the system of the present invention their main corporate bank so the application can be sent to this bank first. If the merchant does not have a banking relationship or they wish the system to include in the quotes the surrounding banks, the system then matches the zip code of the merchant to the closest banks to their Zip code and sends the application to these banks for a quote. This allows smaller banks to offer additional services to their corporate accounts. The merchant can also include national syndicated banks and banks internationally. The merchant at their option can also select an offshore bank. The only requirement of the bank is it be linked to a processing center (Network). If a bank is not in a processing center network then the system of the present invention must enter into a relationship with the bank to either become a discrete bank or place them in a processing center.

The present invention allows a purchaser to be able to select a form of payment different than the manually entered credit card. It is an object of the present invention to allow a purchaser to choose payments, including, manual entered credit card, card present transaction using outside company proprietary devices (i.e., eConnect, eCashPad), PIN Debit transactions using the same type of card present devices, on-line check, savings account drafts, money market checks, margin security check, on-line credit line pulls, wire transfers, sight drafts, letter's of credit, etc. It is an object of the present invention to treat all forms of payments outside of credit card as an ACH transaction where funds are pulled immediately from the purchaser's account if funds are available.

It is an object of the present invention to provide a purchaser the ability to interact with a processing center on-line in selecting alternative payment methods if the method chosen by the purchaser does not have available funds.

It is an object of the present invention to provide a foreign currency exchange during the shopping cart experience if the purchaser has selected an ACH form of payment. The merchant can predefine their home currency in the set up of the shopping cart as part of their e-Commerce site. The purchaser is prompted to provide their home currency as part of the shopping cart experience and the system accesses the clearing bank currency exchange rates and converts the merchant currency into the purchaser currency. The purchaser currency amount is the amount of money that the processing center will use as determining if the proper amount of funds is available to approve the purchase. Banking systems today have the process for currency exchange.

It is an object of the present invention to provide an encryption process for a transaction. It is an object of the present invention to take a transaction and encrypt it as the purchaser loads the data into the shopping cart payment process. The data is not stored other than on their screen at the time of data entry. The encryption process is only de-encrypted when the transaction reaches the processing center. Therefore, the purchaser is provided the same level of financial security that the current traditional business transaction model provides. Once the transaction reaches the processing center, it is placed in the same bonded secured transaction processing system as other banking transactions today. All international, national and local banking rules and regulations currently followed by the processing centers will be the same for processing payments over the Internet.

It is an object of the present invention to provide escrow services to purchasers using the ACH payment types. These services protect the purchaser against loss of money and the process of interacting with merchants from around the world to retrieve monies lost due to fraud. It is an object of the present invention that each ACH transaction be placed into an escrow account on behalf of the purchaser and held there until the merchant completes the transaction. Completing the transaction means shipment of the goods and verification of the bill of lading with the carrier or completing the service with the purchaser verifying receipt of such services. Once the transaction is complete the escrow service will electronically match and clear the transaction by moving the funds out of the escrow account into the merchant account. After the period of time has elapsed that the purchaser has selected for escrow, the escrow service provides notification to the purchaser that the time limit of their escrow has ended and allows the purchaser either to extend the escrow or request a refund of their funds. Based upon the purchaser's direction, the system either extends the escrow or refunds the money to the purchaser in the same manner as the purchaser used to pay for the product or service. The purchaser may experience a gain or loss in their own currency with the proper disclosures at the time of the purchase based upon the currency exchange rates at the time of closing their escrow.

It is an object of the present invention to provide an accounting system that stores all the details of the transactions for retrieval. Anyone who is directly involved with each transaction has the capability under the present invention of obtaining on-line real time reports, print reports or batch files to support their individual system needs. The reporting capabilities can come from each processing center with the data only being accessible by the parties involved with the transaction. (Merchant, Purchaser, Process Center, etc.). All financial payment data (i.e., credit card, bank account, etc.) will only be made available by the processing center to the individual purchaser and to the banks. No one will have access to anyone's financial information.

### BRIEF DESCRIPTION OF THE DRAWINGS

FIG. 1 illustrates the prior art method for conducting e-commerce financial transactions.

FIG. 2 illustrates the system integration of the present invention.

FIGS. 3a-3b illustrate the merchant accounting processing of the present invention.

FIGS. 4a-4d illustrate the Internet purchaser transaction process.

### DETAILED DESCRIPTION OF THE INVENTION

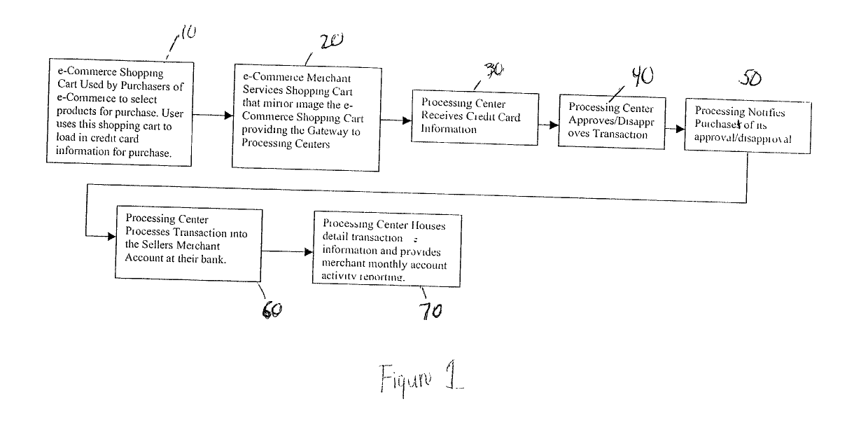

FIG. 1 relates to the prior art system for conducting e-commerce financial transactions. An e-commerce shopping cart is used by purchasers of e-commerce to select products for purchase 10. A user uses this shopping cart to load credit card information for purchase. The financial shopping cart has the mirror image of the e-commerce shopping cart providing the gateway to processing centers 20. The Processing Center receives the credit card information 30. The processing center approves/disapproves the transaction 40. The processing center notifies the purchaser of its approval/disapproval 50. The Processing Center processes the transaction into the seller's merchant account at their bank 60. In a preferred embodiment, the processing center houses the detailed transaction information and provides the merchant scheduled account activity reporting, for example monthly reporting.

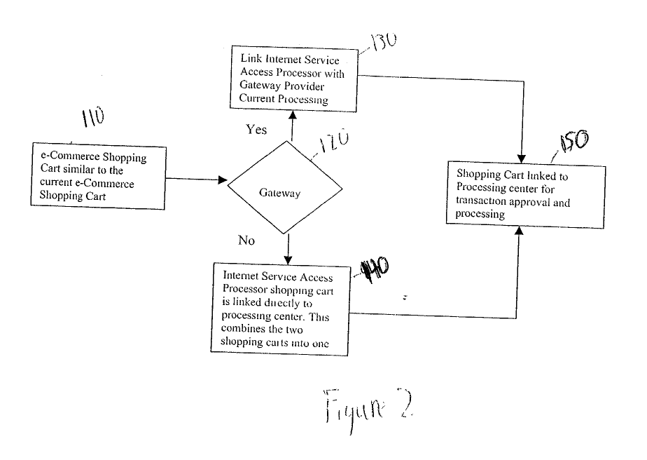

FIG. 2 illustrates the system integration of the present invention. An e-commerce shopping cart 110 similar to the e-commerce shopping cart in FIG. 1 is sent to gateway 120. If there is a gateway then it is linked to the Internet service access processor with the gateway provider current processing 130. If there is no gateway, then the Internet service access processor shopping cart is linked directly to the processing center 140. This combines the two shopping carts into one. From steps 130 or 140, the shopping cart is linked to the processing center for transaction approval and processing. 150.

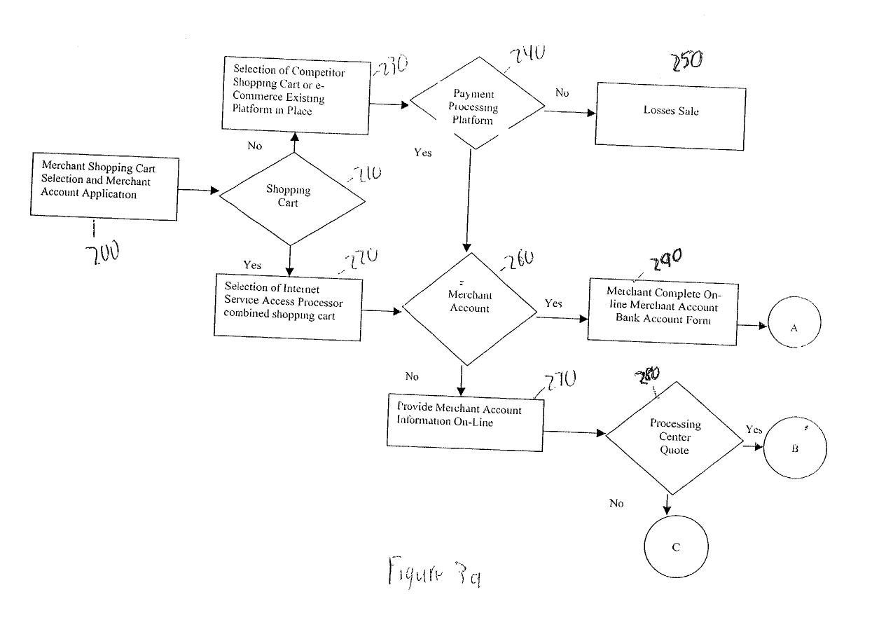

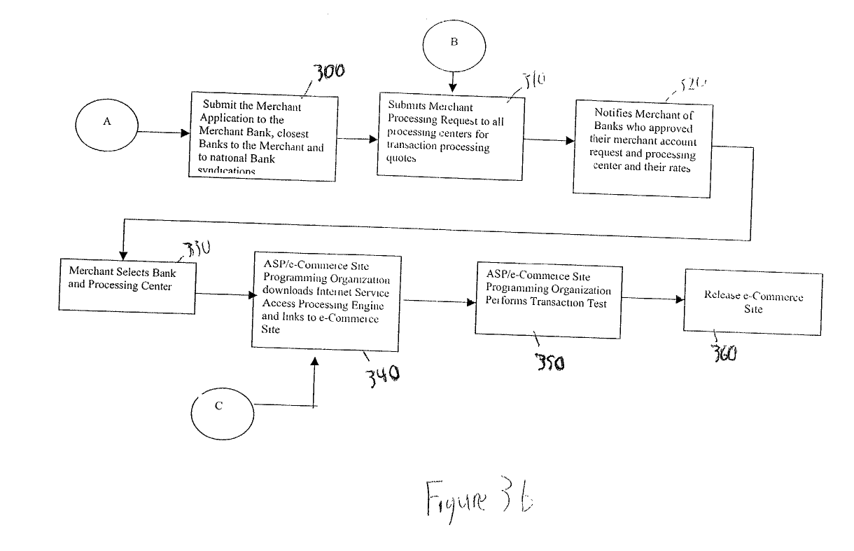

FIGS. 3a-3b illustrate the merchant accounting processing of the present invention. The system of the present invention provides a merchant shopping cart selection and merchant account application 200. A user chooses a shopping cart 210. The shopping cart can be the shopping cart of the present invention 220 which is the Internet service access processor combined shopping cart, or another shopping cart or e-commerce existing platform 230. If a user chooses the other type of shopping cart 230 then there must be a payment processing platform 240 or the sale is lost 250. If the other type of shopping cart has a payment processing platform or the user chooses the combined shopping cart then a merchant account 260 is created. The merchant can either provide merchant account information on-line 270, which is then sent to the processing center for a quote 280 or the merchant can complete an online merchant account bank account form 290.

Referring to FIG. 3b, if the merchant completes step 290, then the merchant submits the merchant application to the merchant's bank, the closest banks to the merchant and/or to national bank syndications 300. If the merchant follows steps 270 and 280 or after step 300, the merchant submits the merchant processing request to all processing centers for transaction processing quotes 310. The system of the present invention then notifies the merchant of banks who approved their merchant account request and processing center and their rates 320. The merchant then selects their bank and processing center 330. If the user does not get a processing center quote 280, or after step 330, the ASP/e-commerce site programming organization downloads Internet service access processing engine and links this to the e-commerce site 340. In a preferred embodiment, the ASP/e-commerce site programming organization performs a transaction test 350. The system of the present invention then releases the e-commerce site 360.

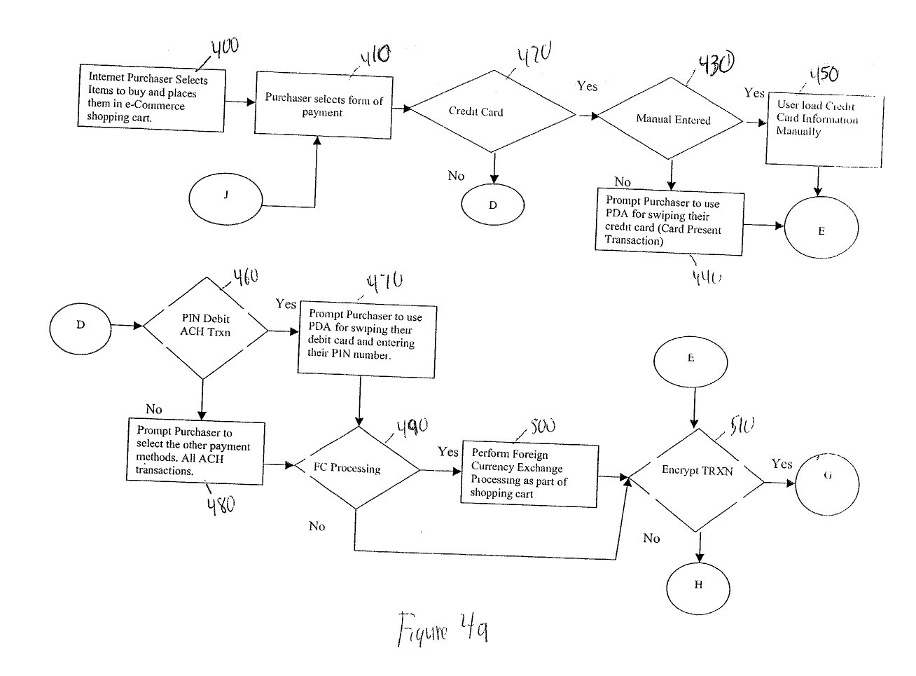

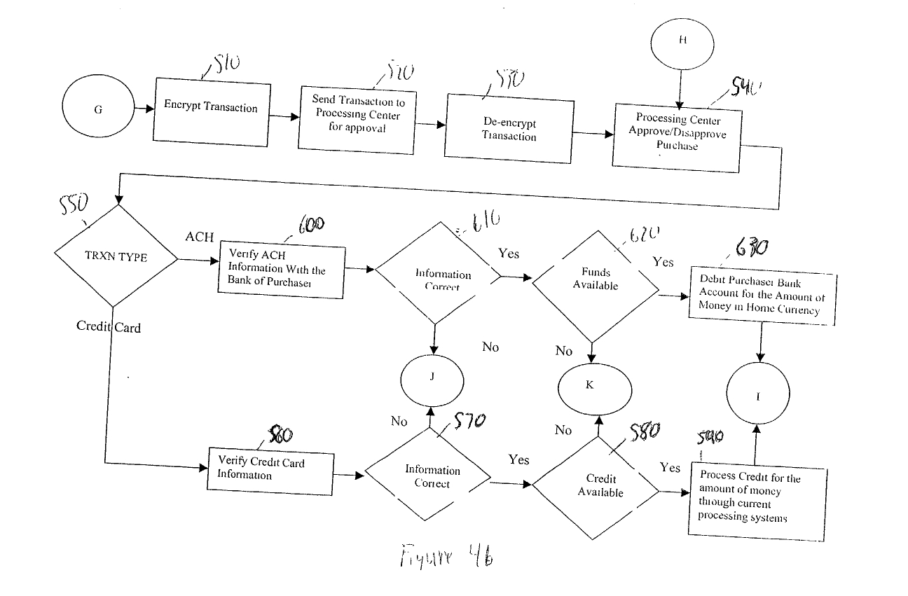

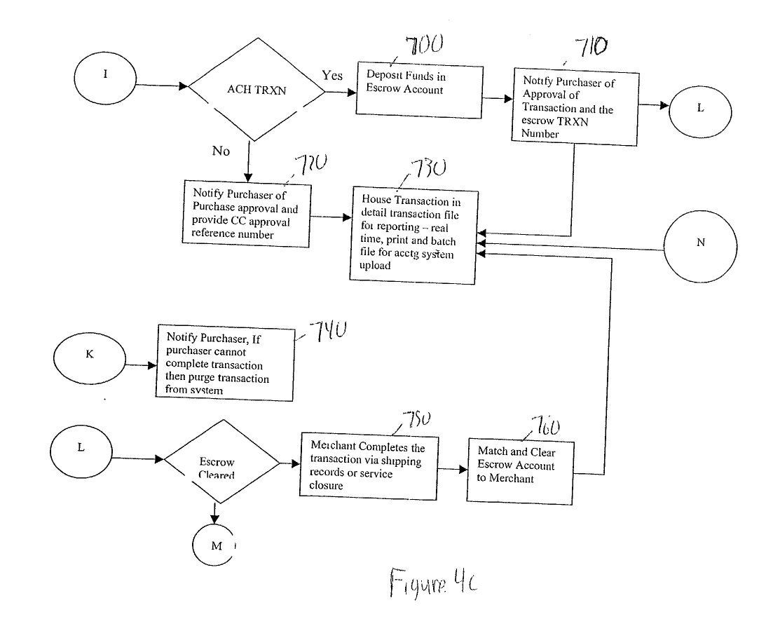

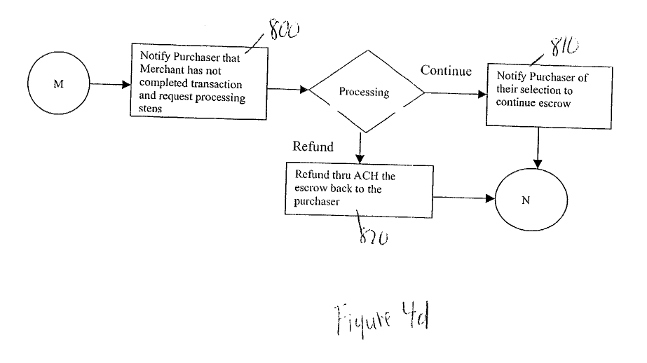

FIGS. 4a-4d illustrate the Internet purchaser transaction process. An Internet purchaser selects items to buy and places them in an e-commerce shopping cart 400. The purchaser then selects the form of payment 410. If the user selects a credit card 420 then the credit card can be manually entered 430 or the user can use a PDA for swiping their credit card 440 (card present transaction). If the user chooses 430 the user loads the credit card information manually 450.

If a user does not use a credit card for payment, the user can then choose to pay via a PIN debit or an ACH transaction 460. If a user chooses a PIN debit the system prompts the user to use their PDA for swiping their debit card and entering their PIN number 470. If the user does not choose 470, the system prompts the purchaser to select other payment methods 480 of which all ACH transactions are included. The system of the present invention then processes the information 490 from steps 470 or 480. If needed, the system of the present invention can perform foreign currency exchange processing 500 as part of the shopping cart. After processing 490, or steps 440, 450 or 500 the transaction information can then be encrypted 510. After the transaction is encrypted, it is sent to the processing center for approval 520. The processing center then de-encrypts the transaction 530. If the transaction was not encrypted the transaction is sent to the processing center for approval 520. At the processing center the transaction is either approved or disapproved 540. At the processing center it is then determined the type of transaction 550. If the transaction is a credit card, the credit card information is verified 560. If the information is incorrect the system can then ask the purchaser to select another form of payment. If the information is correct 570, then the system determines whether there is credit available 580. If the credit is available, the system processes the credit card for the amount of money through current processing systems 590. If the system determines there is not enough credit available, the system can ask the user if they want to choose another payment method.

If the transaction type is an ACH, then the system verifies the ACH information with the bank of the purchaser 600. The system determines if the information is correct 610. If the information is not correct, the purchaser is informed and can reenter the information or select another method of payment. If the information is correct, then the system determines if the funds are available 620. If the funds are not available via the chosen method of the user, the purchaser is informed and can select another method of payment. If the funds are available, the debit purchase bank account is notified for the amount of money in home currency 630.

If the ACH transaction is approved, the funds are deposited in an escrow account 700. The purchaser is then notified of the approval of the transaction and the escrow transaction number 710. If the transaction was not an ACH transaction and the payment was approved, then the purchaser is notified of the approval and provided a credit card approval reference number 720. In a preferred embodiment, after steps 710 and 720, the system provides a detailed transaction file for reporting real time, print and batch file for accounting system upload 730.

If a purchaser cannot provide correct information or sufficient funds to complete a transaction then all information concerning the transaction is purged from the system 740.

After step 710 of the system of the present invention, the merchant completes the transaction via shipping records, service closure or another method accepted in the industry 750. The funds in the escrow account relating to that transaction are then sent to the merchant 760. This information is then also provided to 730. If the merchant has not completed the transaction in a certain amount of time, the purchaser is notified 800. The purchaser can then notify the system that they wish the system to continue to hold the funds in escrow for a certain length of time 810, or the purchaser can then seek a refund through the ACH back to the purchaser 820. This information can again be stored in 730.

In the claims:

1. A system for providing financial transactions on the Internet comprising:
a merchant bank linked to a processing center;
forms of payment; and
an escrow system.

2. The system of claim 1 wherein said system matches a zip code of said merchant to banks having Zip codes nearby and sends an application to said banks for a quote.

3. The system of claim 1 wherein said banks include national syndicated banks, international banks and offshore banks.

4. The system of claim 1 wherein said form of payment is selected from the group consisting of; manual entered credit card, card present transaction using outside company, proprietary devices (i.e., eConnect, eCashPad), PIN Debit transactions using same type of card present devices, on-line check, savings account drafts, money market checks, margin security check, on-line credit line pulls, wire transfers, sight drafts, letter's of credit, and similar forms of payment.

5. The system of claim 4 wherein all forms of payments outside of credit card are treated as an ACH transaction where funds are pulled immediately from a purchaser's account if funds are available.

6. The system of claim 1 wherein a purchaser can interact with a processing center on-line in selecting alternative payment methods if said first form of payment chosen by a purchaser does not have available funds.

7. The system of claim 1 further comprising;
a foreign currency exchange for a purchaser if an ACH form of payment has been selected.

8. The system of claim 1 further comprising
an encryption process for encrypting a transaction.

9. The system of claim 8 wherein said encryption process takes a transaction and encrypts it as a purchaser loads data into a shopping cart payment process.

10. The system of claim 8 wherein said encryption process is only de-encrypted when said transaction reaches said processing center.

11. The system of claim 1 wherein each ACH transaction is placed into an escrow account on behalf of a purchaser and held there until said merchant completes said transaction.

12. The system of claim 11 further comprising;
said system electronically matching and clearing said transaction by moving finds out of said escrow into a merchant account.

13. The system of claim 12 wherein said system provides notification to said purchaser that a time limit of said escrow has ended and allows said purchaser either to extend said escrow or request a refund of funds.

14. The system of claim 1 further comprising;
an accounting system that stores details of transactions for retrieval.

15. A method for providing financial transactions on the Internet comprising:
providing a shopping cart selection and merchant account application;
linking an e-commerce shopping cart to a processing center;
choosing a shopping cart;
creating a merchant account;
providing merchant account information;
submitting said merchant account information to a bank;
submitting said merchant processing request to processing centers for transaction processing quotes;
notifying said merchant of banks who approved said merchant account request and processing center and their rates; and
selecting said bank and processing center.

16. The method of claim 15 wherein said shopping cart is selected from the group consisting of an Internet service access processor combined shopping cart, or another shopping cart or e-commerce existing platform.

17. The method of claim 16 wherein said another type of shopping cart has a payment processing platform.

18. The method of claim 15 wherein if said user does not get a processing center quote, an ASP/e-commerce site programming organization downloads Internet service access processing engine and links this to an e-commerce site.

19. The method of claim 18 wherein said ASP/e-commerce site programming organization performs a transaction test.

20. A method for shopping online comprising;
placing items to purchase in an e-commerce shopping cart;
selecting a form of payment;
processing information regarding said purchase by sending said information to a processing center;
determining at said processing center whether said purchase is approved;

21. The method of claim 20 wherein if said form of payment is a credit card then said credit card can be manually entered or said user can use a PDA for swiping said credit card.

22. The method of claim 21 wherein said form of payment is selected from the group consisting of a PIN debit or an ACH transaction.

23. The method of claim 22 wherein if said user chooses said PIN debit said user is prompted to use said PDA for swiping said debit card and entering a PIN number.

24. The method of claim 23 wherein if said user does not choose to enter said PIN number, system prompts said purchaser to select other payment methods of which all ACH transactions are included.

25. The method of claim 20 further comprising;
performing foreign currency exchange processing of said purchase.

26. The method of claim 20 further comprising;
encrypting said purchase information then de-encrypting said information at said processing center.

27. The method of claim 20 further comprising;
determining type of transaction at said processing center.

28. The method of claim 20 wherein if said transaction is a credit card, verifying information on said credit card.

29. The method of claim 28 wherein if said information relating to said credit card is incorrect said purchaser can select another form of payment.

30. The method of claim 28 further comprising;
determining whether credit is available on said credit card.

31. The method of claim 30 wherein if credit is available on said credit card; processing said credit card for amount of money required by said purchase.

32. The method of claim 30 wherein if credit is not available, asking the user to choose another payment method.

33. The method of claim 22 wherein if the transaction type is an ACH, said system verifies the ACH information with a bank of said user.

34. The method of claim 33 wherein said system determines if information regarding said ACH is correct.

35. The method of claim 33 wherein if said ACH information is incorrect, said user is informed and can reenter said information or select another method of payment.

36. The method if claim 34 wherein if said information is correct determining if funds are available.

37. The method of claim 36 wherein if said funds are not available said user is informed and can select another method of payment.

38. The method of claim 36 wherein if said funds are available, a debit purchase bank account is notified for amount of money in home currency.

39. The method of claim 38 wherein if said ACH transaction is approved, said funds are deposited in an escrow account.

40. The method of claim 39 further comprising;
notifying said purchaser of said approval of said transaction and said escrow account number.

41. The method of claim 31 wherein if payment is approved notifying said purchaser of the approval and providing a credit card approval reference number.

42. The method of claim 20 further comprising;
providing a detailed transaction file for reporting real time, print and batch file for accounting system upload.

43. The method of claim 40 wherein after said merchant completes the transaction, said funds in said escrow account relating to that transaction are sent to said merchant

44. The method of claim 40 wherein if said merchant has not completed the transaction in a certain amount of time, said purchaser is notified.

45. The method of claim 44 wherein said purchaser can notify said system to continue to hold said funds in escrow for a certain length of time or said purchaser can seek a refund through said ACH back to said purchaser.
